(19) United States
(12) Patent Application Publication
(10) Pub. No.: US 2016/0189264 A1
(43) Pub. Date: Jun. 30, 2016

(54) METHOD AND SYSTEM FOR GARAGE DOOR SALE AND MAINTENANCE PRESENTATION AT POINT OF SERVICE

(71) Applicant: Thomas A. Mello, II, Scottsdale, AZ (US)

(72) Inventor: Thomas A. Mello, II, Scottsdale, AZ (US)

(21) Appl. No.: 14/980,176

(22) Filed: Dec. 28, 2015

Related U.S. Application Data
(60) Provisional application No. 62/097,042, filed on Dec. 27, 2014.

(51) Int. Cl. G06Q 30/06; G06Q 10/00

(52) U.S. Cl. CPC G06Q 30/0613; G06Q 30/0627; G06Q 30/0635; G06Q 10/20

(57) ABSTRACT

A method and system for a garage door sale and maintenance presentation at the point of service is disclosed. A computer based multimedia sales tool that is useful for sales and maintenance presentations with a customer at their garage. The application program can show a new garage door design overlaid on top of the existing garage door on the house. The application program can additionally present photos of failing parts and the need for repairs. The application program includes the ability to document customer equipment issues.

### CROSS REFERENCE TO RELATED APPLICATIONS

This application claims priority to U.S. Provisional Patent Application to Thomas A. Mello entitled “Method for Garage Door Sale and Maintenance Presentation at Point of Service,” Ser. No. 62097042, filed Dec. 27, 2014, the disclosure of which is hereby incorporated entirely herein by reference.

### BACKGROUND OF THE INVENTION

1. Technical Field

This invention relates to a method and system for a garage door sale and maintenance presentation at the point of service.

2. State of the Art

Visual sales presentations are described, for example, in U.S. Pat. No. 7,019,759, which describes a software system useful for presenting a finished look to a home by use of sample homes and door designs. However, this system is lacking in many important details for a retrofit home. A particular home with installed landscape, custom paint, and potentially other installed features is not practical to present to a customer in a drawing format. Drawings, even if available, will not be an accurate picture of a home with color and other options being used.

There are estimated to be about 75,000 technicians installing garage doors and making repairs each year. These technicians are a very important part in making sales. For example, when a technician makes a call to look at a malfunctioning door, they have the ability to sell a home owner a new door, repair the old one, or comment on the owner's possibility of self installing a new door or self-repairing the old door. In practice, many homeowners do not have the capability of repairing their door, or, they would rather let a qualified person repair the door and pay for it.

If the garage door is impractical to repair (a newly installed door is less expensive than repairing the malfunctioning door), the homeowner is faced not only with choosing new door features, they are also faced with the possibility of changing the door's appearance. This can be a difficult decision and a homeowner may hesitate to make a purchase commitment when options need to be researched. Hesitation on the part of the homeowner can lead to a loss of a sale.

The homeowner's difficult decision includes choosing the color, number of panels, whether or not windows are included, embossed texture, among other things are important considerations for homeowner pride.

It would be helpful to give the technician the tools needed to make a sales presentation conveniently and accurately to the home owner. An ability to price a door, know the delivery, and allow a homeowner to choose a satisfactory door that will not be returned for appearance reasons.

Another situation that the technician faces is a garage door that needs to be repaired. When a door is malfunctioning, it is helpful for the technician to document what went wrong (by taking a photo) and to present this evidence to the homeowner. The evidence might include a broken part, excessive wear, misalignment, shifted adjustments, bent parts, missing pieces, loose or missing fasteners, and evidence of electrical failure (i.e. bums, heat spots). When shown to the homeowner, a sale of new parts is much easier. It is also helpful to document failed parts for communication with a manufacturer of the parts and internally to a door installation company.

Accordingly what is needed, is a way that allows the homeowner to visualize the change from an existing garage door to a new garage door would be helpful to remove the ‘decision obstacle’ to a sale. Further, a technician having access to a convenient sales presentation, equipment and software that addresses garage door sales and maintenance with a customer is desired.

### DISCLOSURE OF THE INVENTION

The disclosed invention relates to a method and system for a garage door sale and maintenance presentation at the point of service.

An embodiment includes a method of presenting sales and maintenance information for a garage door at a customer location comprising: providing a mobile application operable on a mobile computing device, wherein said mobile computing device is configured to display information and capture photos; establishing a network connection between the mobile computing device and a central computer; receiving inspection criteria at the mobile computing device from the central computer in response to operation of the mobile application sending a request for the criteria to the central computer through the network connection; collecting existing garage door information at the customer location using the mobile application operating on the mobile computing device, wherein the mobile application guides a technician through a multi-point inspection automatically presented at a display of the mobile computing device, wherein the multi-point inspection corresponds to the inspection criteria; automatically sending the existing garage door information from mobile computing device to a central computer in response to completing the multi-point inspection, wherein the central computer automatically generates sales and maintenance information in response to processing the existing garage door information; sending the sales and maintenance information from the central computer to the mobile computing device; and automatically presenting the sales and maintenance information through the display of the mobile computing device operating the mobile application.

Another embodiment includes A system for a garage door sale and maintenance presentation at a point of service comprising: a mobile computing device wherein said mobile computing device comprises a display for displaying information, an input device and a camera for taking photos; a mobile application stored and operating on the mobile computing device; a central computer in network connection with the mobile computing device, wherein the mobile computing device; and a software application stored and operating on the central computer, wherein the mobile computing device operating the mobile application collects existing garage door information and communicates the existing garage door information to the central computer through the network connection and the central computer automatically generates sales and maintenance information in response to processing the existing garage door information.

Another embodiment may include A method of presenting sales and maintenance information at a customer location comprising: providing a mobile application operable on a mobile computing device, wherein said mobile computing device is configured to display information and capture photos; establishing a network connection between the mobile computing device and a central computer; receiving inspection criteria at the mobile computing device from the central computer in response to operation of the mobile application sending a request for the criteria to the central computer through the network connection; collecting existing project information at the customer location using the mobile application operating on the mobile computing device, wherein the mobile application guides a technician through a multi-point inspection automatically presented at a display of the mobile computing device, wherein the multi-point inspection corresponds to the inspection criteria; automatically sending the existing project information from mobile computing device to a central computer in response to completing the multi-point inspection, wherein the central computer automatically generates sales and maintenance information in response to processing the existing project information; sending the sales and maintenance information from the central computer to the mobile computing device; and automatically presenting the sales and maintenance information through the display of the mobile computing device operating the mobile application.

The foregoing and other features and advantages of the present invention will be apparent from the following more detailed description of the particular embodiments of the invention, as illustrated in the accompanying drawings.

### BRIEF DESCRIPTION OF THE DRAWINGS

A more complete understanding of the present invention may be derived by referring to the detailed description and claims when considered in connection with the Figures, wherein like reference numbers refer to similar items throughout the Figures, and:

FIG. 1 shows a mobile computing device interface configured according to an embodiment of the invention;

FIG. 2 shows a garage door presentation according to an embodiment of the invention;

FIG. 3 shows a garage door presentation according to an embodiment of the invention;

FIG. 4 is a flow chart of a method of presenting sales and maintenance information for a garage door at a customer location; and

FIG. 5 is a flow chart of a method of presenting sales and maintenance information at a customer location.

### DETAILED DESCRIPTION OF EMBODIMENTS OF THE INVENTION

As discussed above, embodiments of the present invention relate to a method and system door a garage door sale and maintenance presentation at the point of service. The point of service, for example, may be the customer's home or business.

Further, a technician having access to a convenient sales presentation, equipment and software that addresses sale points with a customer is desired. Two of the sales points are directed to a new garage door that allows a customer to view their home with a new garage door and what is needed to repair an existing garage door.

It is important that any sales presentation software is convenient and easy for a technician to prepare for a customer quickly and with little effort. The effort should include a visual of the customer's actual garage door, with a new door overlaid.

A separate organizational need for a garage door company to have any customer issues properly documented. It would be helpful for a technician to use the same equipment that allows for rapid and convenient photo taking according to a standard inspection criterion. Additionally, for warranty and maintenance purposes, it would be helpful for the garage door company to document any work done at a customer site.

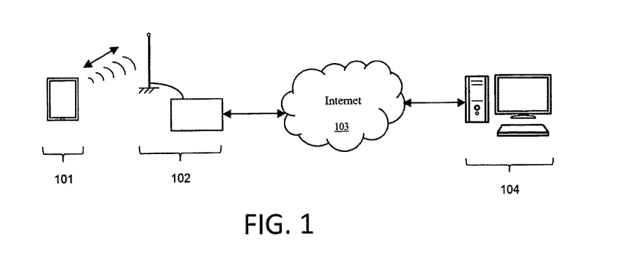

FIG. 1 shows a mobile computing device 101, such as a smart phone, a computer tablet, a laptop and the like, connected to a mobile phone gateway device 102, such as a cell tower, connected to internet 103. The mobile computing device 101 is preferably connected directly to mobile phone gateway device 102, but alternately, is connected to internet 103 directly through other means, such as, but not limited to a Wi-fi connection, a mobile hotspot and the like. In at least this way, the mobile computing device 101 establishes a network connection with a central computer 104. The central computer 104 contains files that are needed by the mobile computing device 101 for displaying sales, maintenance and/or other suitable information needed for a sales call and presentation by a technician. Mobile computing device 101 includes a mobile application that is used to display customer sales information, and additionally, includes image taking, editing, storing, and/or manipulation functions. Mobile computing device 101 further includes locally stored files that the mobile application uses to function. Central computer 104 includes files, programs, and videos that are useable by mobile computing device 101 operating the mobile application. Central computer 104 also operates a software application, wherein the software application operates on the central computer to process data communicated from the mobile computing device and store the same in a memory associated with a particular customer.

Suitable information needed for a repair/sales call includes, for example, a video library for garage door installation and repair; documents that show a technician how to install and repair garage doors; and/or garage door trouble shooting information.

When making a call upon a customer, the technician completes a multi-point garage door inspection utilizing the mobile application. The technician may initiate the mobile application on the mobile computing device 101. Once the mobile application is initiated, the mobile application displays on the display of the mobile computing device 101, a guided inspection user interface, wherein the guided inspection includes a set of criteria for documenting important aspects of any garage door operation by taking photos according to an inspection criterion. The inspection criteria may include inspection of major and/or moving parts and is customizable. The criteria may be generated on the central computer 104 utilizing the software application. The created criteria may then be stored on memory of the central computer 104. The mobile application operating on the mobile computing device 101 may request the created criteria from the central computer 104 and the central computer 104 may send the criteria to the mobile computing device 104 through the established network connection. The criteria may be displayed on the display of the mobile computing device 101 as a multi-point inspection. The multi-point inspection, as performed using the mobile computing device 101 includes required steps in order to complete the multi-point inspection. For example, and without limitation, some embodiments of the system 100 include taking photos of at least two garage door items when directed by the mobile application. In these embodiments, the technician cannot proceed further in the multi-point inspection until the photos are taken by the mobile computing device 101 and stored associated with the criteria presented by the mobile computing device 101 operating the mobile application. The photos are used for record keeping and presentation to a customer for decisions with respect to any repairs. The photos may also be used for warranty and negligence purposes. The photos may be taken utilizing a camera of the mobile computing device 101.

The collection of photos on the mobile computing device 101, along with any multi-point inspection notes, will help to collect data on common part failures, and also help identify cause and effect of any wear or failure for future reference. The inspections can also be performed on a defined frequency (such as semi-annual). All of the data collected by the mobile computing device 101 operating the mobile application program may be transmitted to the central computer 104 for storage and archival purposes.

In addition to information for a sales presentation, central computer 104 includes a library of digital files containing manuals, garage door options and parts, installation information, and/or installation videos in a readily available format for downloading from the central computer 104 to mobile computing device 101 through the established network connection. The download may occur in response to receiving a request from the mobile application operating on the mobile computing device. Manuals are available from the garage door manufacturer, or from the supplier of parts. Videos can be developed by the garage door company.

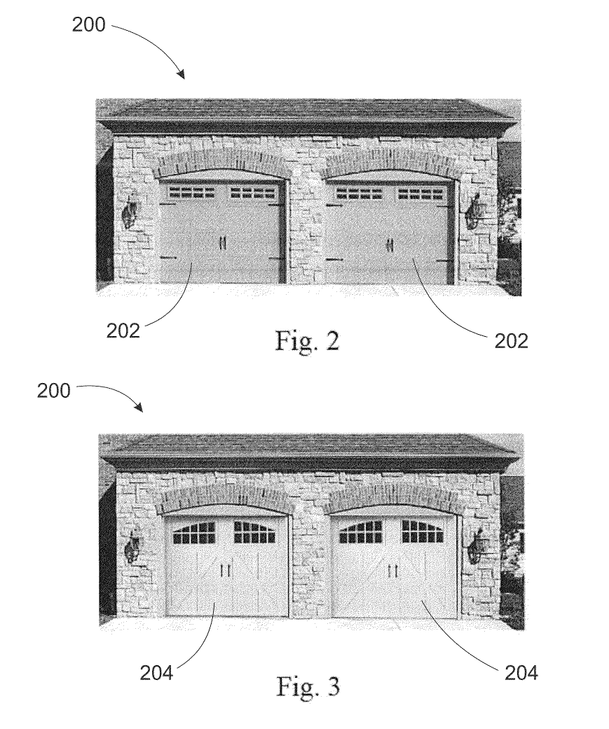

As shown in FIGS. 2 and 3 a garage door change may be presented to a customer. FIG. 2 shows a photo of a customer's existing garage door area 200 having a garage door 202. FIG. 3 shows customer's existing garage door area 200 having a new garage door design 204, overlaid on garage door 202. The mobile application operating on the mobile computing device 101 may be utilized for presenting the new garage door design 204 overlaid on the garage door 202. For example, a technician may take a photo of the customer's existing garage door area 200 using the camera of the mobile computing device 101. The mobile application operating on the mobile computing device 101 may then operate to provide a plurality of new garage door designs 204, wherein the technician may select one of the new garage door designs 204 and overlay the garage door 202 with the selected new garage door design 204. This may be done by utilizing layering of image files, wherein the selected new garage door design 204 is an image file that can be layered over the captured image of the garage door area 200 and sized to overlay the garage door 202. The selecting and overlaying process may be performed using input/output devices. It will be understood that input/output devices may include a touch screen interface on the mobile computing device. In this way, a customer can rapidly choose a satisfactory design and see immediately how it impacts the appearance.

A further embodiment includes using mobile computing device 101 to verify the installation and/or any repairs. For example, an overall photo of a new installation can be taken, or if repairs are made, any new parts installed. A photo of the warranty sticker placed on the garage door can also be used to verify the technician's work and to assist with future customer calls.

In another embodiment, the application program includes a work order checklist for maintenance/repairs. The technician launches' the mobile application and then passes or fails items on the work order checklist. If an item fails, the technician takes a photo of the item. The technician then shows actual photos and animations of what will happen if the item is not repaired/replaced.

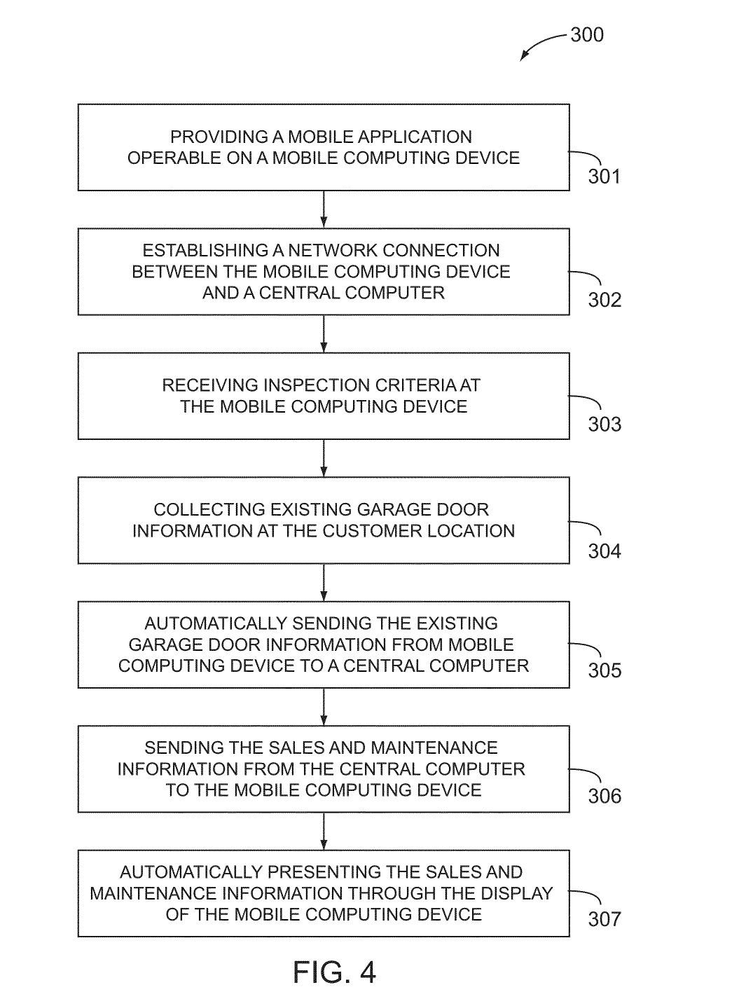

Referring again to the drawings, FIG. 4 depicts a flow chart of a method 300 of presenting sales and maintenance information for a garage door at a customer location. The method 300 comprises Step 301 of providing a mobile application operable on a mobile computing device, wherein said mobile computing device is configured to display information and capture photos; Step 302 of establishing a network connection between the mobile computing device and a central computer; Step 303 of receiving inspection criteria at the mobile computing device from the central computer in response to operation of the mobile application sending a request for the criteria to the central computer through the network connection; Step 304 of collecting existing garage door information at the customer location using the mobile application operating on the mobile computing device, wherein the mobile application guides a technician through a multi-point inspection automatically presented at a display of the mobile computing device, wherein the multi-point inspection corresponds to the inspection criteria; Step 305 of automatically sending the existing garage door information from mobile computing device to a central computer in response to completing the multi-point inspection, wherein the central computer automatically generates sales and maintenance information in response to processing the existing garage door information; Step 306 of sending the sales and maintenance information from the central computer to the mobile computing device; and Step 307 of automatically presenting the sales and maintenance information through the display of the mobile computing device operating the mobile application.

In performing the method 300, the mobile computing device takes a photo of an existing garage having an existing garage door and superimposes a new garage door generated by the central computer over the existing garage door on the mobile computing device. Further, the inspection criteria include a work order checklist for maintenance of the garage door.

The method 300 may further include automatically requiring a photo to be taken by the mobile computing device operating the mobile application in response to an item on the work order checklist failing during inspection; and automatically presenting an animation of possible outcomes of operating a failing component at the display of the mobile computing device in response to an item on the work order checklist failing.

The method 300 may also comprise initiating sales through the mobile application operating on the mobile computing device.

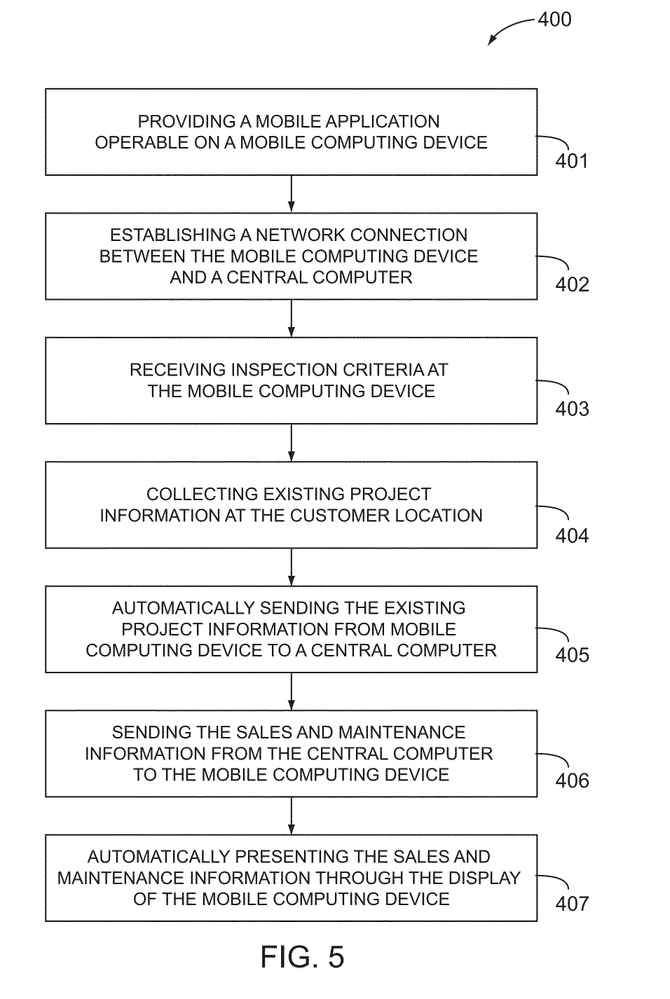

Referring to the drawings, FIG. 5 depicts a flow chart of a method 400 of presenting sales and maintenance information at a customer location. It will be understood that the system may be used for any type of project in various service industries. Accordingly, the method 400 comprises Step 401 of providing a mobile application operable on a mobile computing device, wherein said mobile computing device is configured to display information and capture photos; Step 402 of establishing a network connection between the mobile computing device and a central computer; Step 403 of receiving inspection criteria at the mobile computing device from the central computer in response to operation of the mobile application sending a request for the criteria to the central computer through the network connection; Step 404 of collecting existing project information at the customer location using the mobile application operating on the mobile computing device, wherein the mobile application guides a technician through a multi-point inspection automatically presented at a display of the mobile computing device, wherein the multi-point inspection corresponds to the inspection criteria; Step 405 of automatically sending the existing project information from mobile computing device to a central computer in response to completing the multi-point inspection, wherein the central computer automatically generates sales and maintenance information in response to processing the existing project information; Step 406 of sending the sales and maintenance information from the central computer to the mobile computing device; and Step 407 of automatically presenting the sales and maintenance information through the display of the mobile computing device operating the mobile application.

In performing the method 400, the inspection criteria include a work order checklist for maintenance regarding the particular project. The method 400 may further include automatically requiring a photo to be taken by the mobile computing device operating the mobile application in response to an item on the work order checklist failing during inspection; and automatically presenting an animation of possible outcomes of operating a failing component at the display of the mobile computing device in response to an item on the work order checklist failing.

The method 400 may further comprise initiating sales through the mobile application operating on the mobile computing device.

As will be appreciated by one skilled in the art, aspects of the disclosed system and method for a garage door sale and maintenance presentation at the point of service may be embodied as a system, method, or computer program product. Accordingly, aspects may take the form of an entirely hardware embodiment, an entirely software embodiment (including firmware, resident software, micro-code, etc.) or an embodiment combining software and hardware aspects that may all generally be referred to herein as a “circuit,” “module” or “system.” Furthermore, aspects may take the form of a computer program product embodied in one or more computer readable medium(s) having computer readable program code embodied thereon.

Any combination of one or more computer readable medium(s) may be utilized. The computer readable medium may be a computer readable signal medium or a computer readable storage medium. A computer readable storage medium may be, for example, but not limited to, an electronic, magnetic, optical, electromagnetic, infrared, or semiconductor system, apparatus, or device, or any suitable combination of the foregoing. More specific examples (a non-exhaustive list) of the computer readable storage medium would include the following: an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a magnetic storage device, or any suitable combination of the foregoing. In the context of this document, a computer readable storage medium may be any tangible medium that can contain, or store a program for use by or in connection with an instruction execution system, apparatus, or device.

A computer readable signal medium may include a propagated data signal with computer readable program code embodied therein, for example, in baseband or as part of a carrier wave. Such a propagated signal may take any of a variety of forms, including, but not limited to, electro-magnetic, optical, or any suitable combination thereof. A computer readable signal medium may be any computer readable medium that is not a computer readable storage medium and that can communicate, propagate, or transport a program for use by or in connection with an instruction execution system, apparatus, or device.

Program code embodied on a computer readable medium may be transmitted using any appropriate medium, including but not limited to wireless, wire-line, optical fiber cable, radio frequence, etc., or any suitable combination of the foregoing.

Computer program code for carrying out operations for aspects of the present invention may be written in any combination of one or more programming languages, including an object oriented programming language such as Java, Smalltalk, C++ or the like and conventional procedural programming languages, such as the “C” programming language or similar programming languages. The program code may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider).

Aspects of the present invention are described herein with reference to flowchart illustrations and/or block diagrams of methods, apparatus (systems) and computer program products according to embodiments of the invention. It will be understood that each block of the flowchart illustrations and/or block diagrams, and combinations of blocks in the flowchart illustrations and/or block diagrams, can be implemented by computer program instructions.

The embodiments and examples set forth herein were presented in order to best explain the present invention and its practical application and to thereby enable those of ordinary skill in the art to make and use the invention. However, those of ordinary skill in the art will recognize that the foregoing description and examples have been presented for the purposes of illustration and example only. The description as set forth is not intended to be exhaustive or to limit the invention to the precise form disclosed. Many modifications and variations are possible in light of the teachings above.

1. A method of presenting sales and maintenance information for a garage door at a customer location comprising:
providing a mobile application operable on a mobile computing device, wherein said mobile computing device is configured to display information and capture photos;
establishing a network connection between the mobile computing device and a central computer;
receiving inspection criteria at the mobile computing device from the central computer in response to operation of the mobile application sending a request for the criteria to the central computer through the network connection;
collecting existing garage door information at the customer location using the mobile application operating on the mobile computing device, wherein the mobile application guides a technician through a multi-point inspection automatically presented at a display of the mobile computing device, wherein the multi-point inspection corresponds to the inspection criteria;
automatically sending the existing garage door information from mobile computing device to a central computer in response to completing the multi-point inspection, wherein the central computer automatically generates sales and maintenance information in response to processing the existing garage door information;
sending the sales and maintenance information from the central computer to the mobile computing device; and
automatically presenting the sales and maintenance information through the display of the mobile computing device operating the mobile application.

2. The method of claim 1, wherein the mobile computing device is a computer tablet, a smartphone or a laptop computer.

3. The method of claim 1, wherein the mobile computing device takes a photo of an existing garage having an existing garage door and superimposes a new garage door generated by the central computer over the existing garage door on the mobile computing device.

4. The method of claim 1, wherein the inspection criteria includes a work order checklist for maintenance of the garage door.

5. The method of claim 4, automatically requiring a photo to be taken by the mobile computing device operating the mobile application in response to an item on the work order checklist failing during inspection.

6. The method of claim 5, automatically presenting an animation of possible outcomes of operating a failing component at the display of the mobile computing device in response to an item on the work order checklist failing.

7. The method of claim 1, further comprising initiating sales through the mobile application operating on the mobile computing device.

8. A system for a garage door sale and maintenance presentation at a point of service comprising:
a mobile computing device wherein said mobile computing device comprises a display for displaying information, an input device and a camera for taking photos;
a mobile application stored and operating on the mobile computing device;
a central computer in network connection with the mobile computing device, wherein the mobile computing device; and
a software application stored and operating on the central computer, wherein the mobile computing device operating the mobile application collects existing garage door information and communicates the existing garage door information to the central computer through the network connection and the central computer automatically generates sales and maintenance information in response to processing the existing garage door information.

9. The system of claim 8, wherein the mobile computing device is a computer tablet, a smartphone or a laptop computer.

10. The system of claim 8, wherein the mobile computing device takes a photo of an existing garage having an existing garage door and superimposes a new garage door over the existing garage door on the mobile computing device.

11. The system of claim 8, further comprising inspection criteria created by the software application operating on the central computer, wherein the central computer sends the inspection criteria to the mobile computing device in response to a request from the mobile application.

12. The system of claim 11, wherein the inspection criteria includes a work order checklist for maintenance of the garage door

13. The system of claim 12, wherein the mobile application operating on the mobile computing device automatically requires a photo to be taken by the mobile computing device in response to an item on the work order checklist failing during inspection.

14. The system of claim 13, wherein the mobile application operating on the mobile computing device automatically presents an animation of possible outcomes of operating a failing component at the display of the mobile computing device in response to an item on the work order checklist failing.

15. A method of presenting sales and maintenance information at a customer location comprising:
providing a mobile application operable on a mobile computing device, wherein said mobile computing device is configured to display information and capture photos;
establishing a network connection between the mobile computing device and a central computer;
receiving inspection criteria at the mobile computing device from the central computer in response to operation of the mobile application sending a request for the criteria to the central computer through the network connection;
collecting existing project information at the customer location using the mobile application operating on the mobile computing device, wherein the mobile application guides a technician through a multi-point inspection automatically presented at a display of the mobile computing device, wherein the multi-point inspection corresponds to the inspection criteria;
automatically sending the existing project information from mobile computing device to a central computer in response to completing the multi-point inspection, wherein the central computer automatically generates sales and maintenance information in response to processing the existing project information;
sending the sales and maintenance information from the central computer to the mobile computing device; and
automatically presenting the sales and maintenance information through the display of the mobile computing device operating the mobile application.

16. The method of claim 15, wherein the mobile computing device is a computer tablet, a smartphone or a laptop computer.

17. The method of claim 15, wherein the inspection criteria includes a work order checklist for maintenance regarding the particular project.

18. The method of claim 17, automatically requiring a photo to be taken by the mobile computing device operating the mobile application in response to an item on the work order checklist failing during inspection.

19. The method of claim 16, automatically presenting an animation of possible outcomes of operating a failing component at the display of the mobile computing device in response to an item on the work order checklist failing.

20. The method of claim 15, further comprising initiating sales through the mobile application operating on the mobile computing device.
